(19) United States
(12) Patent Application Publication
(10) Pub. No.: US 2021/0031336 A1
(43) Pub. Date: Feb. 4, 2021

(54) REVERSIBLE RATCHET WRENCH

(71) Applicant: APEX BRANDS, INC., Apex, NC (US)

(72) Inventor: Alan D. Anderson, Willow Spring, NC (US)

(21) Appl. No.: 16/758,467

(22) PCT Filed: Oct. 24, 2018
(86) PCT No.: PCT/US2018/057405

§ 371 Date: Apr. 23, 2020

Related U.S. Application Data
(60) Provisional application No. 62/577,162, filed on Oct. 25, 2017.

(51) Int. Cl. B25B 13/46

(52) U.S. Cl. CPC B25B 13/463; B25B 23/0035

(57) ABSTRACT

A ratcheting tool is provided. The tool may include a head housing having a cavity, a gear having a plurality of gear teeth, a pawl, and a reversing control member. The pawl may have a plurality of pawl teeth configured to engage with the plurality of gear teeth. The pawl may also be moveable within the cavity into at least one position where at least some of the plurality of pawl teeth engage with at least some of the plurality of gear teeth to prevent rotation of the gear relative to the pawl in a first rotational direction and permit rotation of the gear relative to the pawl in a second rotational direction. The reversing control member configured to interface with the pawl to move the pawl into the at least one position in response to a rotational movement of the reversing control member.

### TECHNICAL FIELD

The example embodiments described herein relate generally to hand tools. More particularly, the example embodiments relate to a wrench that includes a ratcheting feature.

### BACKGROUND

Standard, fixed wrenches require a user to reposition the wrench on a fastener when full revolutions of the fastener cannot be performed due to, for example, obstructions in the turning area. Ratcheting tools, for example ratchet wrenches, allow a user to maintain positioning of the tool on a fastener and provide for turning the fastener in repetitive manner without the need to reposition the tool on the fastener. Such ratcheting wrenches not only provide for an easier user experience, but, in many cases, offer more efficient operation. In this regard, rotation of a fastener may be accomplished using shorter, repeated movements without repositioning the user's hand, even in the absence of an obstruction. While ratcheting tools have become quite ubiquitous, there continues to be a need for further innovation in the area of ratcheting tools.

### BRIEF SUMMARY OF SOME EXAMPLES

Various example embodiments of a ratcheting tool are provided. An example ratcheting tool may comprise a head housing having a cavity, a gear having a plurality of gear teeth disposed about a circumference of the gear and a tang extending along an axis of rotation of the gear, a pawl, and a reversing control member. The pawl may have a plurality of pawl teeth configured to engage with the plurality of gear teeth. The pawl may also be moveable within the cavity into at least one position where at least some of the plurality of pawl teeth engage with at least some of the plurality of gear teeth to prevent rotation of the gear relative to the pawl in a first rotational direction and permit rotation of the gear relative to the pawl in a second rotational direction. The reversing control member may be configured to interface with the pawl to move the pawl into the at least one position in response to a rotational movement of the reversing control member. The reversing control member may have a through hole that houses a spring that directly engages with a rear face of the pawl and directly engages with an interior wall of the cavity.

Another example ratcheting tool may comprise a head housing having a cavity, a gear having a plurality of gear teeth disposed about a circumference of the gear and a tang extending along an axis of rotation of the gear, a pawl, and a reversing control member. The pawl may have a plurality of pawl teeth configured to engage with the plurality of gear teeth. The pawl may also be moveable within the cavity into at least one position where at least some of the plurality of pawl teeth engage with at least some of the plurality of gear teeth to prevent rotation of the gear relative to the pawl in a first rotational direction and permit rotation of the gear relative to the pawl in a second rotational direction. The reversing control member may be configured to interface with the pawl to move the pawl into the at least one position in response to a rotational movement of the reversing control member. The pawl may include an integrated pin, and the reversing control member may include a yoke that receives the integrated pin. The integrated pin may be configured to at least swivel within the yoke to move the pawl in response to rotational movement of the reversing control member.

Another example ratcheting tool comprises a head housing having a cavity, a gear having a plurality of gear teeth disposed about a circumference of the gear and a tang extending along an axis of rotation of the gear, a pawl, and a reversing control member. The pawl may have a plurality of pawl teeth configured to engage with the plurality of gear teeth. The pawl may be moveable within the cavity into at least one position where at least some of the plurality of pawl teeth engage with at least some of the plurality of gear teeth to prevent rotation of the gear relative to the pawl in a first rotational direction and permit rotation of the gear relative to the pawl in a second rotational direction. The reversing control member may be configured to interface with the pawl to move the pawl into the at least one position in response to a rotational movement of the reversing control member. The pawl may include an integrated pin and the reversing control member may include a yoke that receives the integrated pin. The integrated pin may be configured to at least swivel within the yoke to move the pawl in response to rotational movement of the reversing control member, and the reversing control member may include a through hole that houses a spring that directly engages with a rear face of a the pawl and directly engages with an interior wall of the cavity. The through hole of the reversing control member may be disposed between the yoke and the lever of the reversing control member and the through hole of the reversing control member may be disposed between recesses on the rear surface of the reversing control member and the lever of the reversing control member.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 shows an example reversible ratcheting wrench in accordance with an example embodiment;

FIG. 2 shows a bottom side of a head of an example reversible ratcheting wrench in accordance with an example embodiment;

FIG. 3 shows a top side of a head of an example reversible ratcheting wrench in accordance with an example embodiment;

FIG. 4 shows a bottom side perspective view of a head housing of an example reversible ratcheting wrench in accordance with an example embodiment;

FIG. 5 shows a bottom side of a head housing of an example reversible ratcheting wrench in accordance with an example embodiment;

FIG. 6 shows a top side perspective view of a head housing of an example reversible ratcheting wrench in accordance with an example embodiment;

FIG. 7 shows a top side view of a head housing of an example reversible ratcheting wrench in accordance with an example embodiment;

FIG. 8 shows a perspective cross-section view of a head housing of an example reversible ratcheting wrench in accordance with an example embodiment;

FIG. 9 shows a cross-section side view of a head housing of an example reversible ratcheting wrench in accordance with an example embodiment;

FIG. 10 shows a cross-section bottom view of a head housing of an example reversible ratcheting wrench in accordance with an example embodiment;

FIG. 11 shows a perspective cross-section view of a head of an example reversible ratcheting wrench in accordance with an example embodiment;

FIG. 12 shows a perspective top view of an internal ratcheting mechanism of an example reversible ratcheting wrench in accordance with an example embodiment;

FIG. 13 shows a perspective bottom view of an internal ratcheting mechanism of an example reversible ratcheting wrench in accordance with an example embodiment;

FIG. 14 shows a top view of an internal ratcheting mechanism of an example reversible ratcheting wrench in accordance with an example embodiment;

FIG. 15 shows an exploded view of a gear assembly in accordance with an example embodiment;

FIG. 16 shows an assembled view of a post and locking bearing of a gear assembly in accordance with an example embodiment;

FIG. 17 shows an exploded view of a pawl assembly in accordance with an example embodiment;

FIG. 18 shows a bottom view of a pawl in accordance with an example embodiment;

FIG. 19 shows a side view of a pawl in accordance with an example embodiment;

FIG. 20 shows a rear view of a reversing control in accordance with an example embodiment;

FIG. 21 shows a front view of a reversing control in accordance with an example embodiment;

FIG. 22 shows a bottom view of a reversing control in accordance with an example embodiment; and

FIG. 23 shows a cross-section bottom view of a reversing control in accordance with an example embodiment;

FIG. 24 shows a top cross-section view of an internal ratcheting mechanism in accordance with an example embodiment;

FIG. 25 shows a bottom view of an internal ratcheting mechanism actuated for ratcheting in a first direction in accordance with an example embodiment; and

FIG. 26 shows a bottom view of an internal ratcheting mechanism actuated for ratcheting in a second direction in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

According to various example embodiments, a ratcheting tool in the form of, for example, a wrench is provided. Such an example wrench may be configured to ratchet or apply torque to a fastener (e.g., a bolt, a nut, or the like) based on a position of an actuated reversing lever of the wrench and a direction of rotation applied by a user. As such, an example wrench may be configured to permit a user to apply torque on a fastener in either a clockwise or counterclockwise manner, with an ability to ratchet in an opposite direction of rotation. An example wrench may therefore be useful in confined areas that restrict movement of a wrench and to eliminate the need to reposition a wrench on a fastener, even in situations where movement may not be restricted. As further described herein, these and other functionalities are provided by the described example embodiments using innovative structures and configurations.

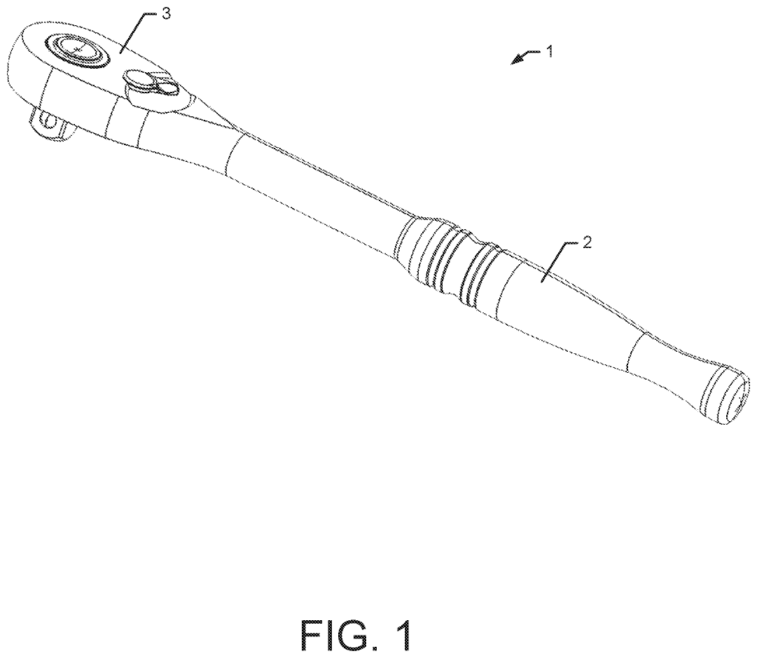

In this regard, FIG. 1 shows an example reversible ratchet wrench 1, according to some example embodiments. In this regard, wrench 1 may include a handle 2 and a head 3. The head 3 may be disposed on a forward portion of the wrench 1. The handle 2 may extend longitudinally away from the head 3 in a rearward direction and provide a grip and have a length to provide leverage for a user. According to some example embodiments, the handle 2 may be generally cylindrical in shape. The head 3 may include a reversible ratcheting mechanism that permits the wrench 1 to apply torque and ratchet in either rotational direction. The head 3 may broaden in width as the head 3 extends away from the handle 2, and the head may have a generally oval or ovoid shape. Within the head 3, the wrench 1 may include a reversing ratcheting mechanism which may be comprised of a gear assembly 100 and a pawl assembly 200. Various components of the wrench 1 may be formed or casted of metals, such as, for example steel or stainless steel.

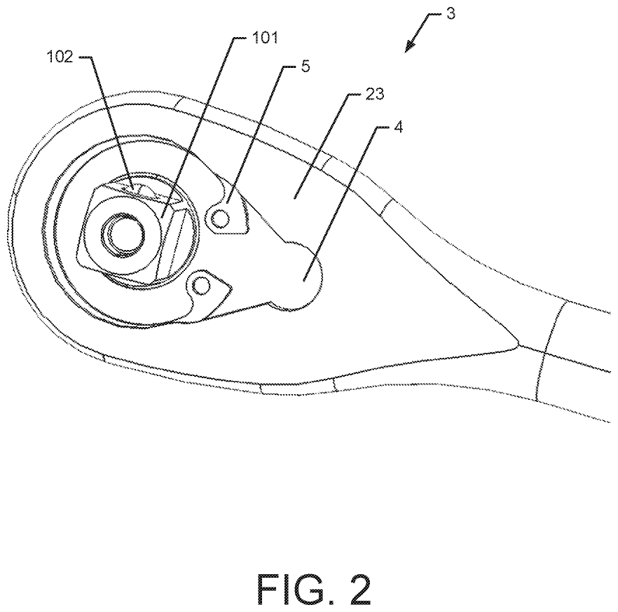

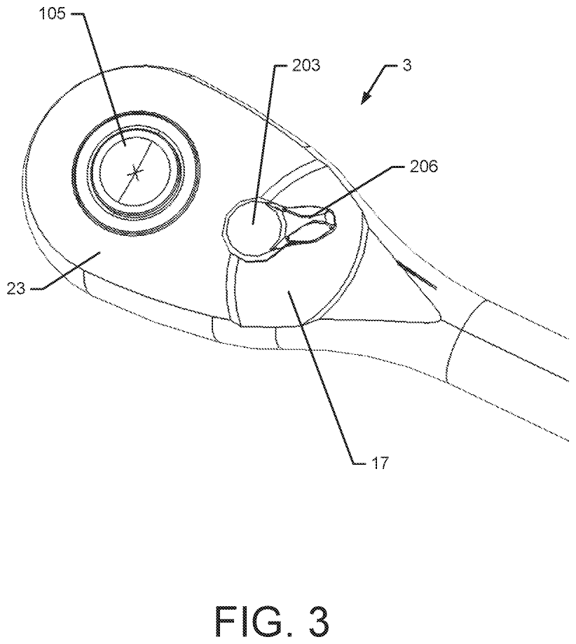

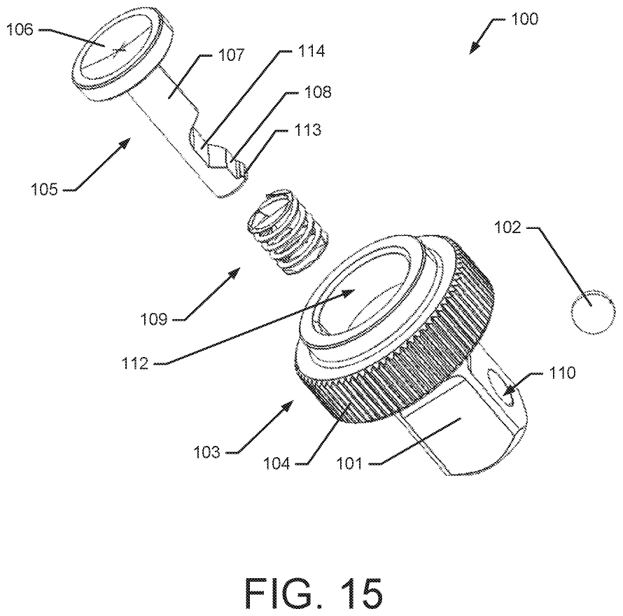

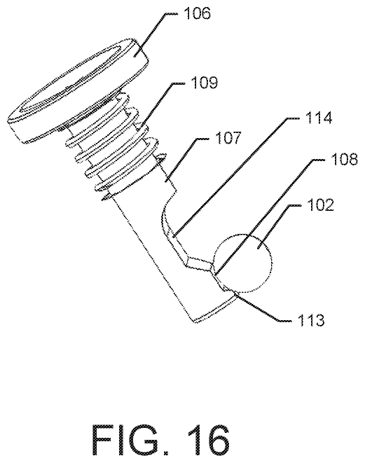

FIGS. 2 and 3 provide more detailed views of the external features of the head 3 of an example reversible ratcheting wrench 1. In this regard, the head 3 may include a head housing 23 that is configured to receive a reversible ratcheting mechanism within a cavity of the head housing 23. FIG. 2 shows a bottom side of a wrench 1 (i.e., the side of the head 3 that would interface with a socket or other attachment and ultimately a fastener). The head 3 may include a cover 4 that operates to maintain the reversing ratcheting mechanism within the head housing 23, with the assistance of a locking ring 5, and protect internal components of the reversible ratcheting mechanism from dirt and debris. Accordingly, the cover 4 may be held in place by the locking ring 5, which may be temporarily deformed to facilitate being installed in a channel in the cavity of the head housing 3, as further described below, to maintain the cover 4 within the cavity. The cover 4 may include an opening through which a tang 101 of the reversing ratcheting mechanism may pass and extend externally to the head 3 to receive, for example, a socket. In some example embodiments, a socket may be locked onto the tang 101 through interaction with the lock bearing 102 disposed within an opening of the tang 101. A top side of the head 3 (i.e., opposite to the bottom side) is shown in FIG. 3. In this regard, the head 3 may include a depressible socket locking post 105 that is accessible through an opening in the head housing 23. The operation and configuration of depressible head 106 is further described below with respect to FIGS. 15 and 16. The head 3 may also include a reversing control member 203 having a lever 206 that may be actuated by a user to change the ratcheting direction of the example wrench 1. The lever 26 may actuate within a recessed area 17, which allows the head 3 to maintain a relatively flat profile on the top surface with no protrusions that might inhibit movement of the wrench 1 in certain environments.

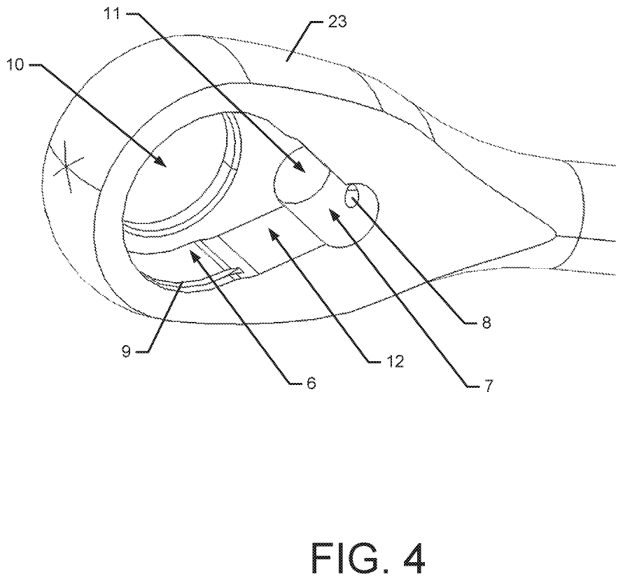

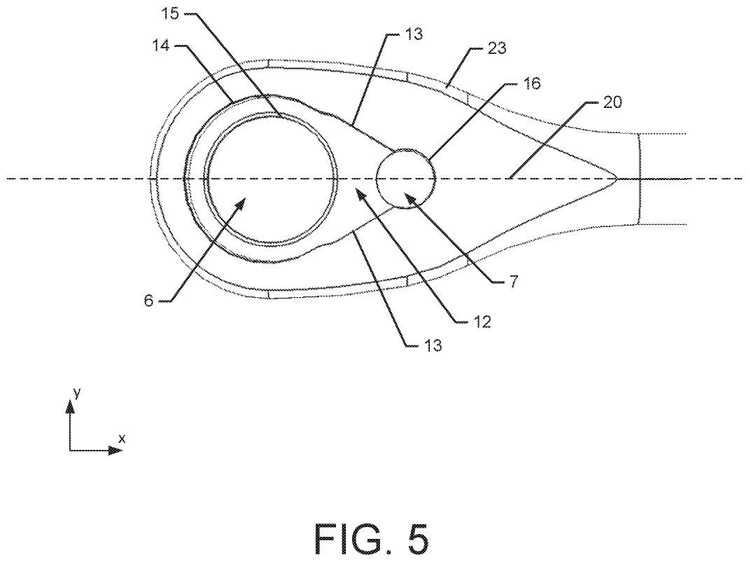

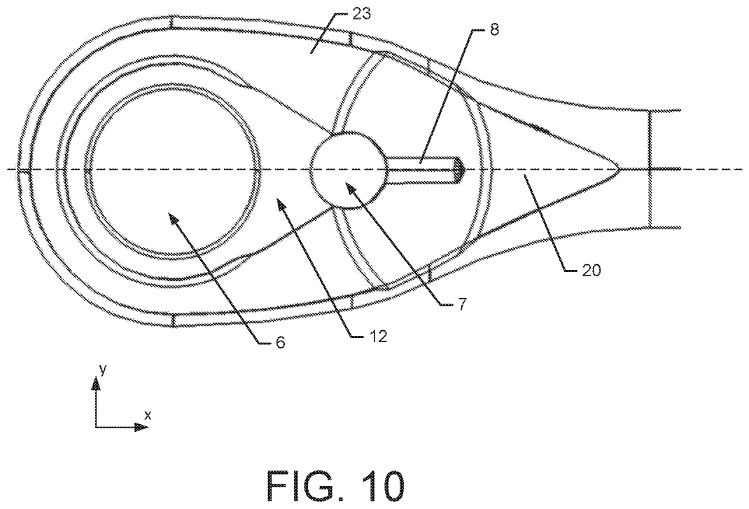

FIGS. 4 through 10 show the head housing 23 in isolation from the other components of the example wrench 1. As mentioned earlier, the head housing 23 includes a cavity that may be separated into a plurality of functional cavities that receive the reversing ratcheting mechanism of the wrench 1 and portions thereof. FIG. 4 shows a perspective bottom side of the head housing 23 and the wrench 1 and FIG. 5 shows a bottom view of the bottom side of the head housing 23. In this regard, the cavity in the head housing 23 may include a gear cavity 6, a pawl cavity 12, and a reversing control cavity 7. While these cavities can be referred to as different cavities, as can be seen best FIGS. 4, 5, and 8, the cavities may be intersecting component cavities of a single cavity in the head housing 23. In this regard, the gear cavity 6 may be generally circular in shape with a forward portion of the gear cavity 6 being a partial circle that is bounded by a cavity edge 14. The gear cavity 6 may have a main opening on the bottom side of the head housing 23 and also a second, upper opening 10 on a top side of the gear cavity 6 that may be circular in shape and have a smaller diameter than the diameter of the gear cavity 6. According to some example embodiments, the gear cavity 6 may include an interior channel 8 that is disposed within the gear cavity 6 and adjacent to the cavity edge 14 for receiving and maintaining the locking ring 5 shown best in FIG. 2. The pawl cavity 12 may be generally trapezoidal in shape bounded by cavity edges 13 on each side that taper in a rearward direction towards the reversing control cavity 7. The reversing control cavity 7 may be circular in shape with a rearward portion of the reversing control cavity 7 on the bottom side being a partial circle that is bounded by a cavity edge 16. Similar to the gear cavity 6, the reversing control cavity 7 has a top opening 11. Additionally, the reversing control cavity 7 may include a plunger cavity 8 in a rearward position on an internal wall of the reversing control cavity 7. Further, a longitudinal plane 20 may be defined that passes centrally through each of the gear cavity 6, the pawl cavity 12, the reversing control cavity 7, and the plunger cavity 8.

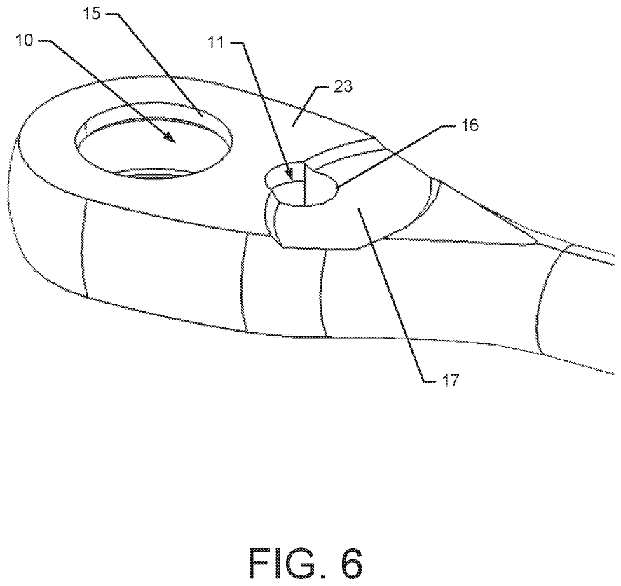

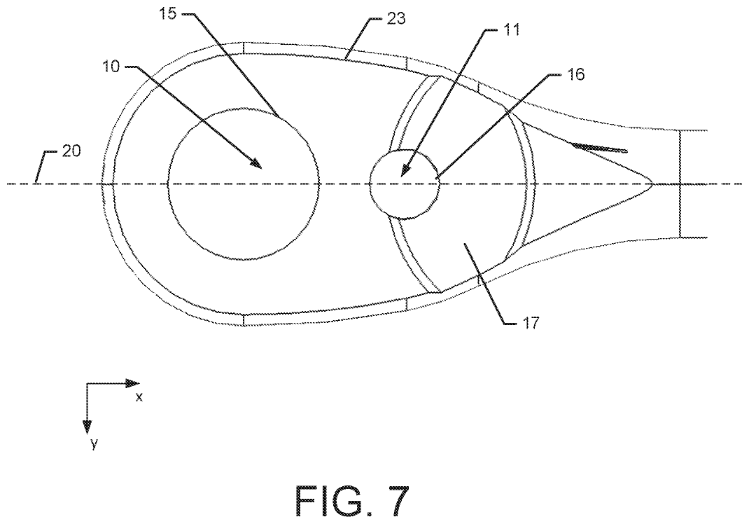

With reference to FIGS. 6 and 7, a top side of the head housing 23 is shown. Openings 10 and 11 are shown from a top side perspective. In this regard, opening edge 15 of opening 10 in the gear cavity 6 may be circular in shape. Further, opening edge 16 of opening 11 in the reversing control cavity 7 may also be circular in shape. Additionally, due to recessed area 17, the opening edge 16 is raised on a forward portion of the opening 11 and is lower at a rearward portion of the opening 11 to facilitate the recessed disposition of the lever 206. Since openings 10 and 11 are located centrally to the head 3, the longitudinal plane 20 also passes through the centers of openings 10 and 11.

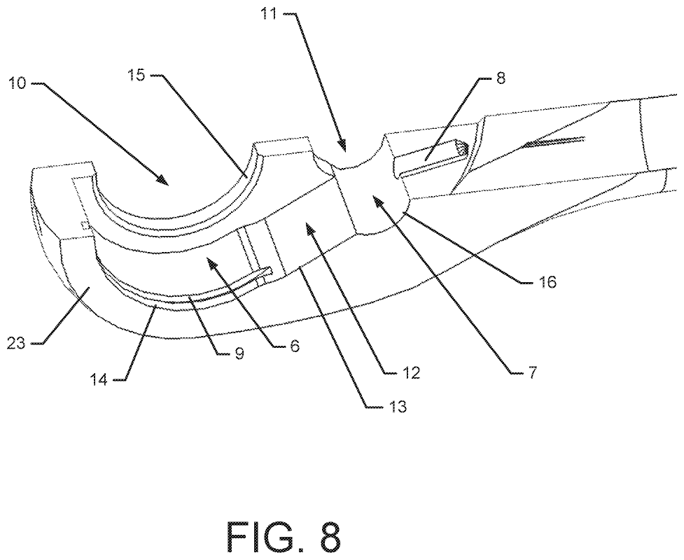

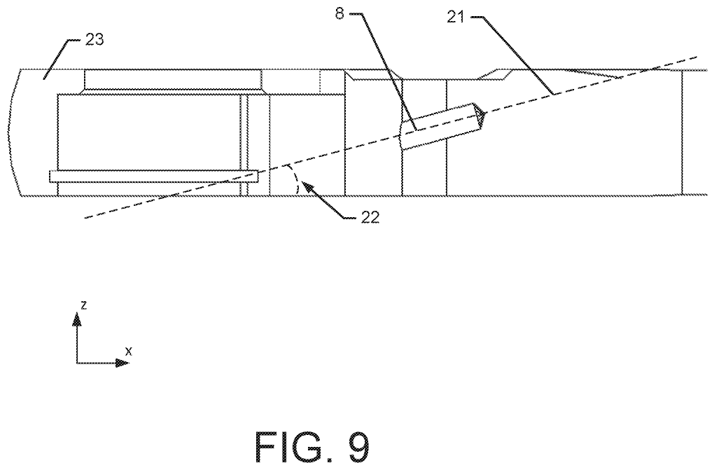

In this regard, FIGS. 8 and 9 provide cross-section views of the head housing 23, with the cross-section cut along the longitudinal plane 20. Further, a line 22 drawn central to the plunger cavity 8 shows that that an elongation of the plunger cavity 8 is not parallel with the top or bottom surfaces of the head housing 23. Rather, the elongation of the plunger cavity 8 forms an acute angle 22 with a bottom surface of the head housing 23.

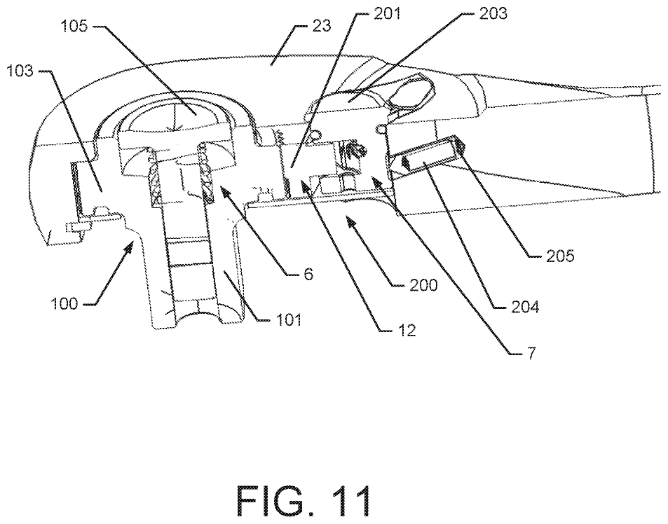

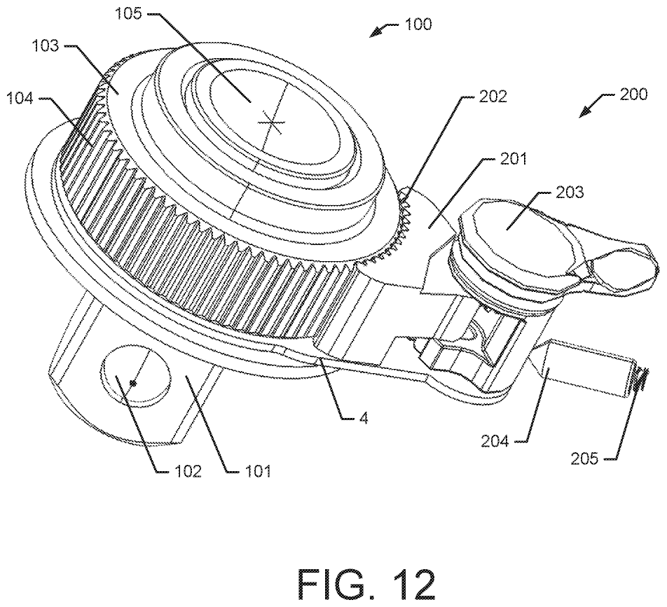

With respect to the cavities formed in the head housing 23, a gear assembly 100 may be received in the gear cavity 6 and a pawl assembly 200 may be received partially in pawl cavity 12 and partially in reversing control cavity 7, as best seen in FIG. 11. The cover 4 may have the general shape of the collection of cavities from the bottom side and the cover may be disposed adjacent and above (i.e., closer to the top side of the head 3) than the locking ring 5 to hold the gear assembly 100 and the pawl assembly 200 in their respective cavities. According to some example embodiments, the cover 4 may rest on and be directly engaged a gear 103 (as best seen in FIG. 12) or other components of the reversing ratcheting mechanism, rather than resting on a ledge in the head housing 23.

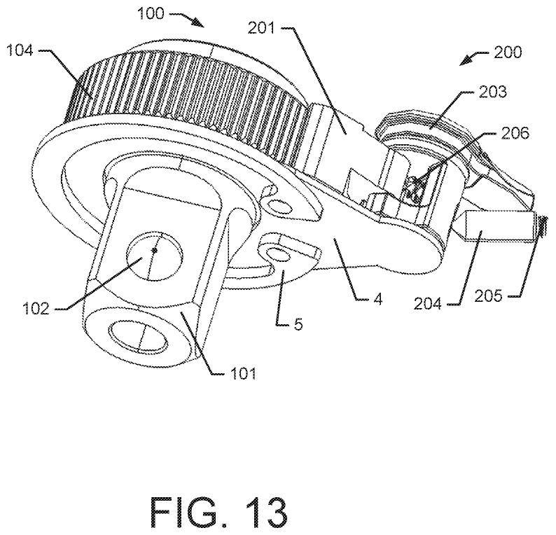

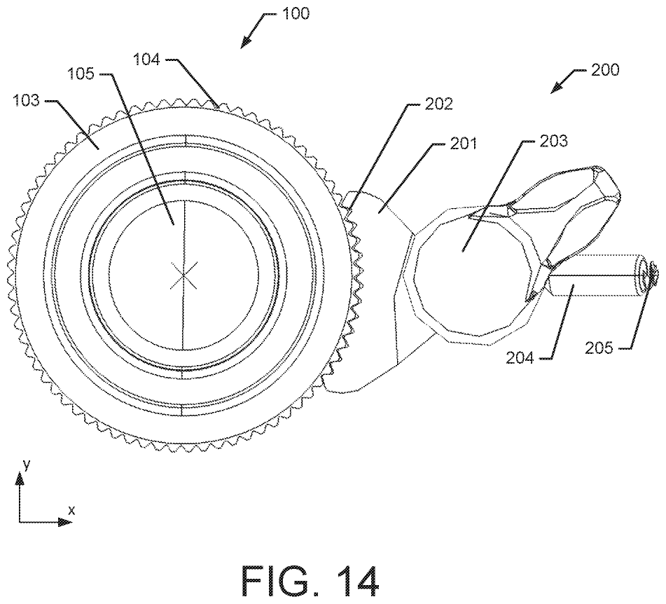

FIGS. 12-14 show a reversing ratcheting mechanism in isolation from the head housing 23 and the handle 2. As indicated earlier, the reversing ratcheting mechanism may be comprised of a gear assembly 100 and a pawl assembly 200. The gear assembly 100 may comprise a gear 103 with teeth 104 encircling a body of the gear 103 on an external face of the gear 103. In other words, the gear 103 may have a plurality of gear teeth 104 disposed about a circumference of the gear 103, and further a tang 101 extending along an axis of rotation of the gear 103. In this regard, the gear 103 may have a circular shape that is elongated into a cylinder to increase the engagement surface area of the teeth 104 for engagement with teeth 202 of the pawl 201. At a base of the cylindrical body of the gear 103, the tang 101 may be axially disposed. Tang 101 may extend away from the cylindrical body in the axial direction, such that, when the gear 103 is positioned in the gear cavity 106, the tang 101 extends beyond the bottom surface of the head housing 23.

According to some example embodiments, the gear assembly 100 may also include a socket locking post 105, best seen in FIGS. 15 and 16. In this regard, according to some example embodiments, the gear 105 may include a cavity 112 that extends from a top surface of the gear 103 into the tang 101. The socket locking post 105 may include a head 106 and a shaft 107. The head 106 may be circular in shape and may be wider than the generally cylindrical shaft 107. The shaft 107 may include an unlocked recess 114, a locked recess 108, and a lip 113. The gear assembly 100 may further include the a spring 109 and the lock bearing 102. A length of the socket locking post 105 may be shorter than a depth of the cavity 112.

In operation, the socket locking post 105 may be depressible by a user to permit the lock bearing 102 to release from an extended, locked position that would lock a socket or other work piece in place on the tang 101, to a retracted, unlocked position that would permit a socket or other work piece to be removed from or installed on the tang 101. In this regard, when assembled, the spring 109 may be disposed around the shaft 107 as shown in FIG. 16, such that the spring 109 applies a bias force on the head 106 of the socket locking post 105 in a direction out of the top side opening in the cavity 112. The socket locking post 105, the spring 109, and the lock bearing 102 may be disposed within the cavity 112 of the gear 103. The lock bearing 102 may be positioned within cavity 112 and extend out of the opening 110 in the tang 102. Opening 110 may have a radius that is smaller than a radius of the lock bearing 102, so that lock bearing 102 may partially extend out of opening 110, but may not pass through opening 110. Engagement between the lock bearing 102, the edge of the opening 110, and the lip 113 of the socket locking post 105 may cause the socket locking post 105 to remain positioned within the cavity 112 against the urging of the spring 112, once assembled. Because the spring 109 urges the socket locking post 105 up and out of the cavity 112, the lock bearing 102 is positioned in the lower and shallower recess 108 (relative to recess 114) when no user force is applied to the head 106, which achieves a locked position. However, when a user depresses the head 106 of the socket locking post 105, the socket locking post 105 can move deeper into the cavity 112. The socket locking post 105 and the shaft 107 may move relative to the lock bearing 102, such that lock bearing 102 aligns with deeper recess 114 and permits lock bearing 102 to retract into the tang 101 and achieve an unlocking position. Upon releasing pressure on the head 106, the lock bearing 102 can move back into recess 108 due to movement of the socket locking post 105 upwards in response to the force exerted by the spring 109, thereby returning to a locked position.

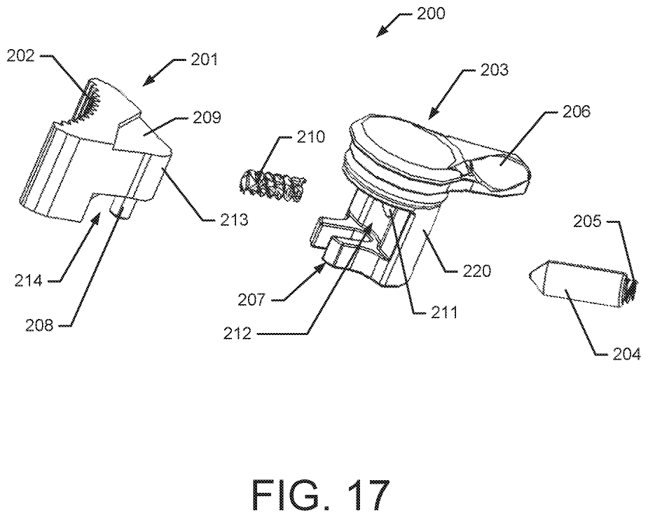

As indicated above, the reversing ratcheting mechanism may also include a pawl assembly 200 that engages with the gear 103 to facilitate reversible ratcheting of the wrench 1. In this regard, the pawl assembly 200, with reference to the exploded view of FIG. 17, may include a pawl 201, a spring 206, and the reversing control member 203. According to some example embodiments, the pawl assembly 200 may also include an auto-reversing preventer assembly comprising a plunger 204 and a spring 205 to bias the plunger 204.

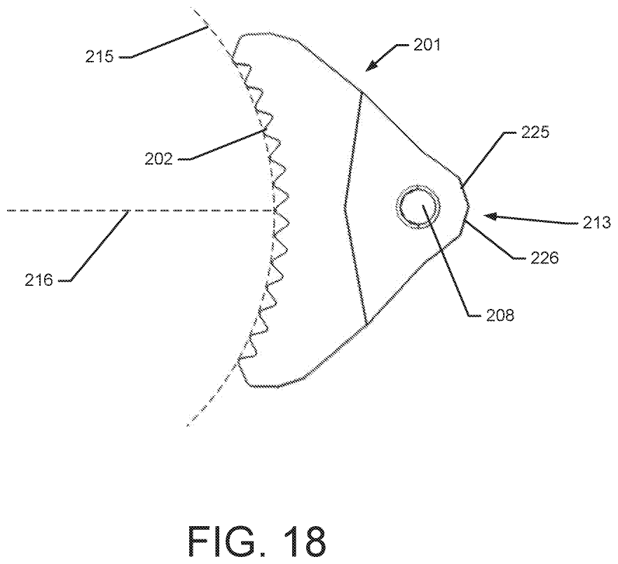

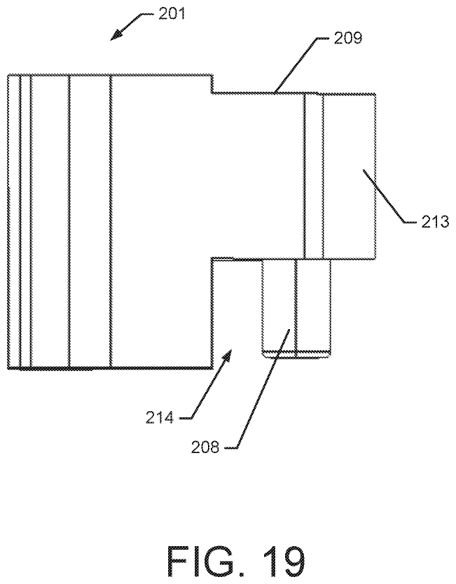

Pawl 201 may have a partially-circular front face with teeth 202 disposed thereon that are configured to engage with the teeth 104 of the gear 103. The pawl 210 may have a plurality of pawl teeth 202 configured to engage with the plurality of gear teeth 104, and the pawl 201 may be moveable within a the pawl cavity 12 into a position where at least some of the plurality of pawl teeth 202 engage with at least some of the plurality of gear teeth 104 to prevent rotation of the gear 103 relative to the pawl 102 in a first rotational direction and permit rotation of the gear 103 relative to the pawl 102 in a second rotational direction. The pawl 201 may be generally triangular shaped with a partially-circular front face. Further, as best seen in FIG. 19, the pawl 201 may include a recessed area 209 on a rear portion of the top side of the pawl 201 and a cutout portion 214 on a rear portion of the bottom side of the pawl 201. The pawl 201 may include an pin 208 that is integrated with the body of the pawl 201 (i.e., formed as a single pawl component) in the cutout portion 214 and extending towards the bottom side of the wrench 1. As shown in FIG. 18, the front face of the pawl 201 with teeth 202 may be formed as a circular arc as indicated by arc 215 which has a radius 216. The circular arc 215 may have complementary curvature to the external face gear 103. In this regard, a radius of curvature of the circumference of the gear 103 and a radius of curvature of the front face of the pawl 201 may be the same length or about or nearly the same length. Further, the pawl 201 may include a rear face 213 that comprises a first surface 225 and a second surface 226, which form an obtuse angle between the surfaces. The first surface 225 may be positioned to engage directly with spring 210 when reversing control member 203 and lever 206 are in a first position. Similarly, the second surface 226 may be positioned to engage directly with spring 210 when reversing control member 203 and lever 206 are in a second position.

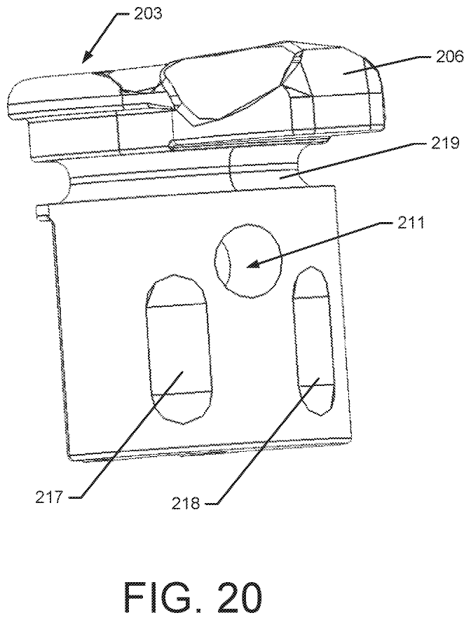

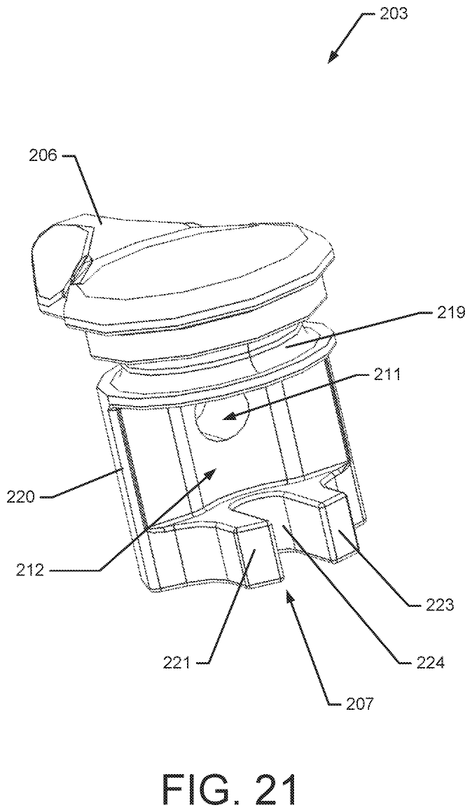

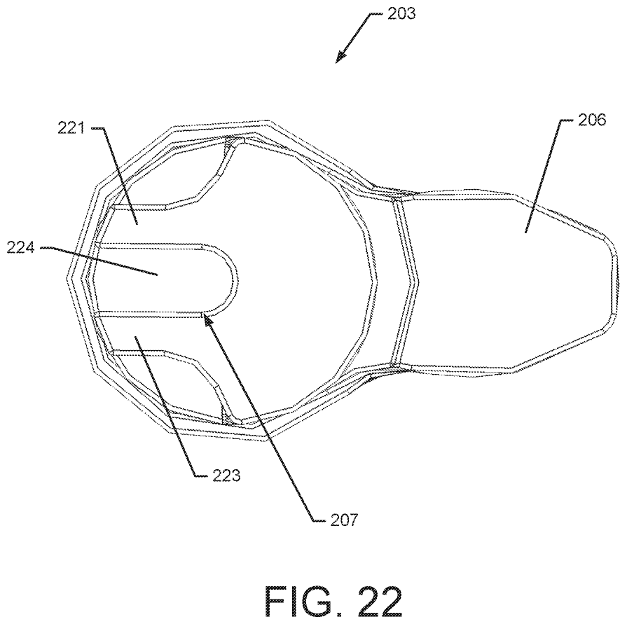

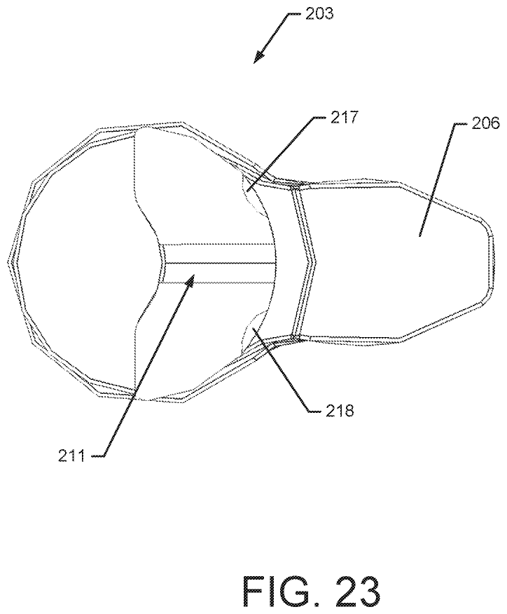

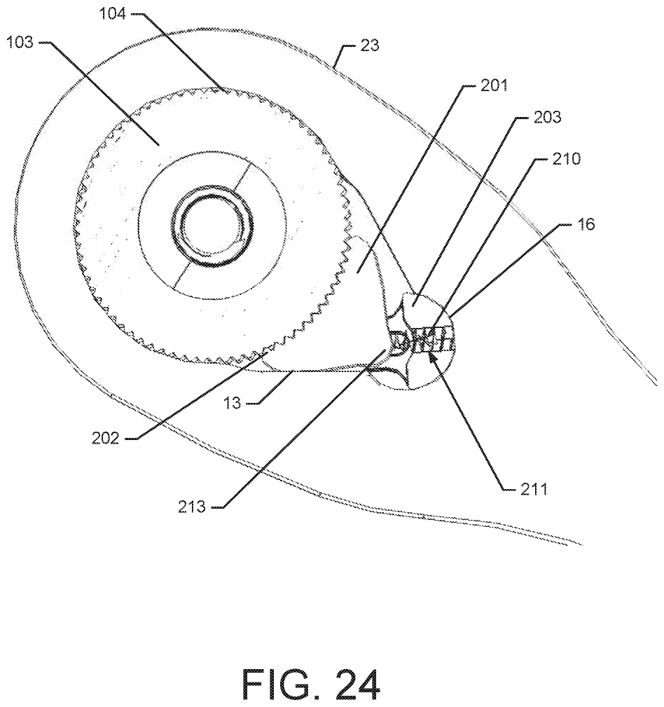

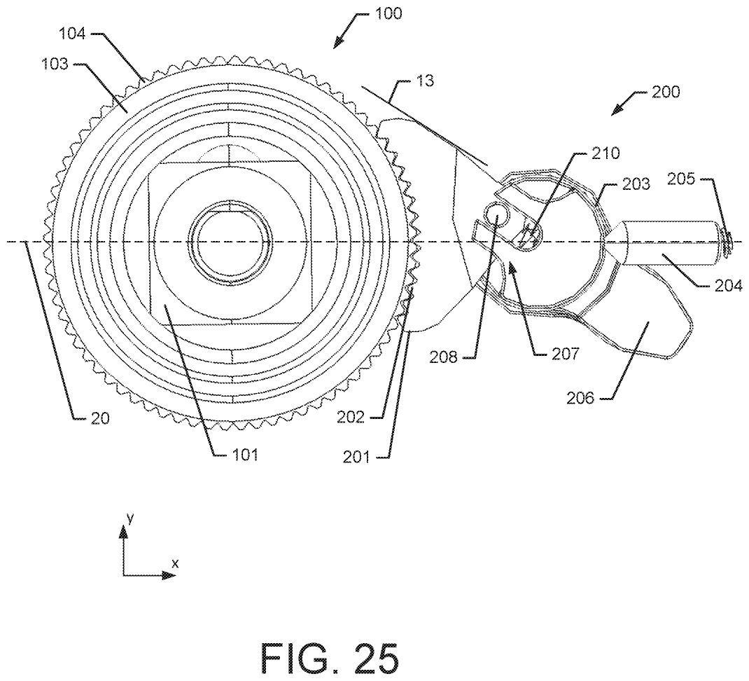

With reference to FIGS. 20-24, the reversing control member 203 is a rotatable component that controls the direction of ratcheting (i.e., clockwise or counter-clockwise) of the wrench 1. The reversing control member 203 may be configured to interface with the pawl 201 to move the pawl 201 into the a position in response to a rotational movement of the reversing control member 203 (e.g., via the lever 206). The reversing control member 203 may have a through hole 211 that houses a spring 210 that directly engages with a rear face 213 of the pawl 201 and directly engages with an interior wall of the cavity 7. In this regard, the reversing control member 203 comprises the lever 206 disposed on a top surface of the reversing control member 203, which protrudes through the opening 11 in the head housing 23 and is the user engagement feature that permits the user to operate the ratchet reversing functionality of the wrench 1. The reversing control member 203 may be generally cylindrical in shape with a void 212 configured to receive the rear portion of the pawl 201 in the body 220 of the reversing control member 203. The reversing control member 203 may also include a through hole 211 that extends from the void 212 to a rear surface of the reversing control member 203. Through hole 211 can be best seen in FIG. 23, which is a cross-section view of the reversing control member 203 from the bottom perspective. The spring 210 may be received in the through hole 211, such that the spring 210 is positioned to directly interface with the rear face 213 of the pawl 201 on one end of the spring 210 and directly interface with an interior rear wall of the reversing control cavity 7 at a position above the plunger cavity 8, as best shown in FIG. 24. As such, when the reversing control member 203 is actuated the spring 210 may rotationally slide on the interior rear wall of the reversing control cavity 7 and across the rear surface 213 of the pawl 201. Below the void 212 on the bottom side of the of the reversing control member 203, the reversing control member 203 may include a yoke 207. The yoke 207 may include two prongs 221, 223 that extend from a lower portion of the body 220 and form a gap 224 there between. The gap 224 may be positioned such that the integrated pin 208 of the pawl 201 is received in the gap 224 when the pawl assembly 200 is assembled, as best seen in FIGS. 24 and 25. According to some example embodiments, the reversing control member 203 may also include a circumferential channel 219 on an upper portion of the body 220 that is configured to receive a gasket that can seal the reversing control member 203 at the edge 16 of opening 11 in the head housing 23.

The reversing control member 203 may also include recesses 217 and 218 (or depressions) on the rear surface of the reversing control member 203 as best seen in FIG. 20. Recesses 217 and 218 may be configured to engage plunger 204, depending on the position of the lever 206, and actuation of the lever 206 may cause the plunger 204 to move between the recesses 217, 218. The plunger 204 may have a tapered or pointed tip for engaging into one of the recesses 217, 218. Plunger 204 may engage with and be biased by a spring 205 that urges the plunger 204 towards the reversing control member 203. In this regard, the plunger 204 and the spring 205 may be disposed in the plunger cavity 8. The plunger 204 may engage with a recess 217, 218 to impede or prevent unintended movement of the reversing control member 203 and unintended reversing of the ratcheting mechanism during use of the wrench 1. Additionally, with respect to the structure of the reversing control member 203, the through hole 211 of the reversing control member 203 may be disposed between the yoke 207 and the lever 206 of the reversing control member 203. Further, the through hole 211 of the reversing control member 203 may be disposed between the recesses 217, 218 and lever 206 of the reversing control member 203.

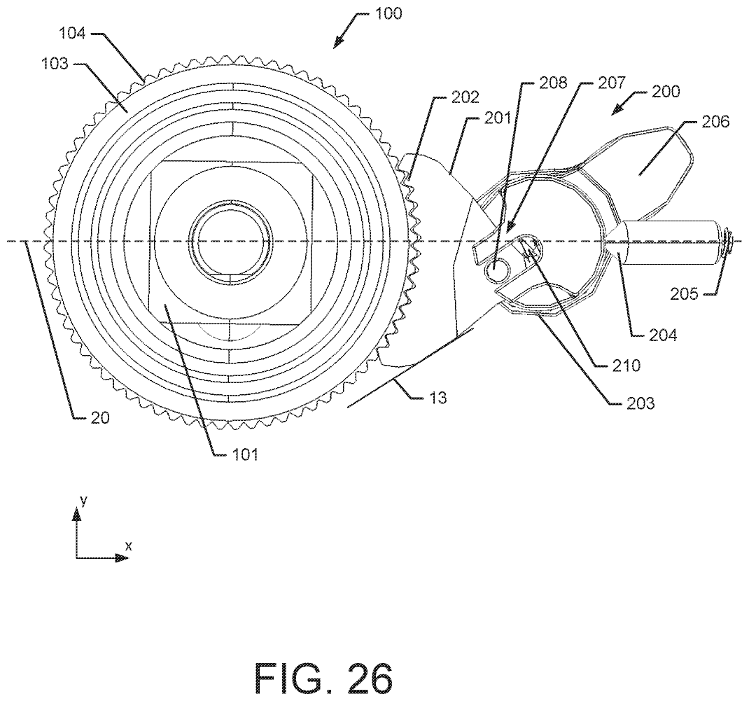

Having described the structural components of the wrench 1, the operation of the reversing ratcheting mechanism will now be described in additional detail with respect to FIGS. 25 and 26. In this regard, FIG. 25 shows an example reversing ratcheting mechanism with a reversing control member 203 positioned to allow the tang 101 to apply torque to a fastener in the clockwise direction and allow ratcheting of the tang 101 in the counter-clockwise direction as viewed from a bottom of wrench 1 (consistent with the view angle of FIG. 25). With the lever 206 actuated in a clockwise direction (when viewed from the bottom), the plunger 204 is forced into recess 217 to hold the reversing control member 203 in a static rotational position and impede or prevent unintended reversing during operation. Further, rotation of the lever 206 and similarly the reversing control member 203 causes the yoke 207 to move the pawl 201 via engagement with the integrated pin 208 of the pawl 201. The reversing control member 203 therefore moves the pawl 201 into a wedged position where the pawl is in contact with the edge 13 of the pawl cavity 12 as shown in FIG. 25. Additionally, spring 210 is in engaged contact with rear surface 226 of the pawl 201 on one end of the spring 210, and the other end of the spring 210 is in engaged physical contact with a rear internal wall of the reversing control cavity 7 of the head housing 23. The spring 210 therefore maintains a force applied to the pawl 201 to facilitate the ratcheting functionality via forced interaction between the teeth 202 of the pawl 201 and the teeth 104 of the gear 103 in the clockwise direction and ratcheting in the counter-clockwise direction.

Further, with respect to FIG. 26, the example reversing ratcheting mechanism is shown with the reversing control member 203 positioned to allow the tang 101 to apply torque to a fastener in the counter-clockwise direction and allow ratcheting of the tang 101 in the clockwise direction viewed from a bottom of wrench 1 (consistent with the view angle of FIG. 26). With the lever 206 actuated in a counter-clockwise direction (when viewed from the bottom), the plunger 204 is forced into recess 218 to hold the reversing control member 203 in a static rotational position and impede or prevent unintended reversing during operation. Further, rotation of the lever 206 and similarly the reversing control member 203 causes the yoke 207 to move the pawl 201 via engagement with the integrated pin 208 of the pawl 201. The reversing control member 203 therefore moves the pawl 201 into a wedged position where the pawl is in contact with the edge 13 of the pawl cavity 12 as shown in FIG. 26. Additionally, spring 210 is in engaged contact with rear surface 225 of the pawl 201 on one end of the spring 210, and the other end of the spring 210 is in engaged physical contact with a rear internal wall of the reversing control cavity 7 of the head housing 23. The spring 210 therefore maintains a force applied to the pawl 201 to facilitate the ratcheting functionality via forced interaction between the teeth 202 of the pawl 201 and the teeth 104 of the gear 103 in the counter-clockwise direction and ratcheting in the clockwise direction.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A ratcheting tool comprising:
a head housing having a cavity;
a gear having a plurality of gear teeth disposed about a circumference of the gear and a tang extending along an axis of rotation of the gear;
a pawl having a plurality of pawl teeth configured to engage with the plurality of gear teeth, the pawl being moveable within the cavity into at least one position where at least some of the plurality of pawl teeth engage with at least some of the plurality of gear teeth to prevent rotation of the gear relative to the pawl in a first rotational direction and permit rotation of the gear relative to the pawl in a second rotational direction; and
a reversing control member configured to interface with the pawl to move the pawl into the at least one position in response to a rotational movement of the reversing control member, the reversing control member having a through hole that houses a spring that directly engages with a rear face of the pawl and directly engages with an interior wall of the cavity.

2. The ratcheting tool of claim 1, wherein the pawl includes a front face upon which the plurality of pawl teeth are disposed, and wherein the front face is shaped as circular arc.

3. The ratcheting tool of claim 2, wherein a radius of curvature of the circumference of the gear and a radius of curvature of the front face of the pawl are about the same length.

4. The ratcheting tool of claim 1, wherein the pawl includes an integrated pin and the reversing control member includes a yoke that receives the integrated pin, wherein the integrated pin is configured to at least swivel within the yoke to move the pawl in response to rotational movement of the reversing control member.

5. The ratcheting tool of claim 1, further comprising a biased plunger that exerts a force on the reversing control member to impede unintended movement of the pawl out of the at least one position during operation of the ratcheting tool.

6. The ratcheting tool of claim 5, wherein the plunger is disposed in a plunger cavity in the head housing and a tip of the plunger engages a recess in the reversing control member.

7. The ratcheting tool of claim 1 further comprising a lock bearing in the tang for engagement with a work piece, the lock bearing being configured to move between a locked and unlocked position.

8. The ratcheting tool of claim 1 further comprising a cover disposed in the cavity of the head housing, the cover being in direct engagement with the gear.

9. The ratcheting tool of claim 1 wherein the through hole of the reversing control member is disposed between the yoke and a lever of the reversing control member.

10. The ratcheting tool of claim 9 wherein the through hole of the reversing control member is disposed between recesses on a rear surface of the reversing control member and the lever of the reversing control member.

11. A ratcheting tool comprising:
a head housing having a cavity;
a gear having a plurality of gear teeth disposed about a circumference of the gear and a tang extending along an axis of rotation of the gear;
a pawl having a plurality of pawl teeth configured to engage with the plurality of gear teeth, the pawl being moveable within the cavity into at least one position where at least some of the plurality of pawl teeth engage with at least some of the plurality of gear teeth to prevent rotation of the gear relative to the pawl in a first rotational direction and permit rotation of the gear relative to the pawl in a second rotational direction; and
a reversing control member configured to interface with the pawl to move the pawl into the at least one position in response to a rotational movement of the reversing control member, wherein the pawl includes an integrated pin and the reversing control member includes a yoke that receives the integrated pin, wherein the integrated pin is configured to at least swivel within the yoke to move the pawl in response to rotational movement of the reversing control member.

12. The ratcheting tool of claim 11, wherein the reversing control member includes a through hole that houses a spring that directly engages with a rear face of a the pawl and directly engages with an interior wall of the cavity.

13. The ratcheting tool of claim 11, wherein the pawl includes a front face upon which the plurality of pawl teeth are disposed, and wherein the front face is shaped as circular arc.

14. The ratcheting tool of claim 13, wherein a radius of curvature of the circumference of the gear and a radius of curvature for the front face of the pawl are about the same length.

15. The ratcheting tool of claim 11, further comprising a biased plunger that exerts a force on the reversing control member to impede unintended movement of the pawl out of the at least one position during operation of the ratcheting tool.

16. The ratcheting tool of claim 15, wherein the plunger is disposed in a plunger cavity in the head housing and a tip of the plunger engages a recess in the reversing control member.

17. The ratcheting tool of claim 11 further comprising a lock bearing in the tang for engagement with a work piece, the lock bearing being configured to move between a locked and unlocked position.

18. The ratcheting tool of claim 11 further comprising a cover disposed in the cavity of the head housing, the cover being in direct engagement with the gear.

19. The ratcheting tool of claim 11 wherein the through hole of the reversing control member is disposed between the yoke and a lever of the reversing control member, and wherein the through hole of the reversing control member is disposed between recesses on a rear surface and the lever of the reversing control member.

20. A ratcheting tool comprising:
a head housing having a cavity;
a gear having a plurality of gear teeth disposed about a circumference of the gear and a tang extending along an axis of rotation of the gear;
a pawl having a plurality of pawl teeth configured to engage with the plurality of gear teeth, the pawl being moveable within the cavity into at least one position where at least some of the plurality of pawl teeth engage with at least some of the plurality of gear teeth to prevent rotation of the gear relative to the pawl in a first rotational direction and permit rotation of the gear relative to the pawl in a second rotational direction; and
a reversing control member configured to interface with the pawl to move the pawl into the at least one position in response to a rotational movement of the reversing control member;
wherein the pawl includes an integrated pin and the reversing control member includes a yoke that receives the integrated pin, wherein the integrated pin is configured to at least swivel within the yoke to move the pawl in response to rotational movement of the reversing control member;
wherein the reversing control member includes a through hole that houses a spring that directly engages with a rear face of a the pawl and directly engages with an interior wall of the cavity; and
wherein the through hole of the reversing control member is disposed between the yoke and a lever of the reversing control member and the through hole of the reversing control member is disposed between recesses in a rear surface of the reversing control member and the lever of the reversing control member.
